(19) United States
(12) Patent Application Publication
(10) Pub. No.: US 2006/0013135 A1
(43) Pub. Date: Jan. 19, 2006

(54) Flow control in a switch

(76) Inventors: Steven G. Schmidt, Westampton, NJ (US); Harry V. Paul, Haddonfield, NJ (US); Henry J. Gonzalez, Belle Mead, NJ (US)

Correspondence Address: BECK AND TYSVER P.L.L.C., 2900 THOMAS AVENUE SOUTH, SUITE 100, MINNEAPOLIS, MN, 55416, US

(21) Appl. No.: 10/873,330

(22) Filed: Jun. 21, 2004

(51) Int. Cl. G01R 31/08

(52) U.S. Cl. 370/235

(57) ABSTRACT

A flow control mechanism is presented that provides XON/XOFF flow control for each virtual channel in an interswitch link. The entire interswitch link remains under standard Fibre Channel BB_Credit flow control. Each virtual channel in the interswitch link can submit data to multiple ports in the downstream switch. The XOFF status of each port in the downstream switch is maintained in an XOFF mask. A mapping between each virtual channel and all ports accessible through the virtual channel is then applied to the XOFF mask, which determines the XOFF status of each virtual channel. An XOFF signal is generated by the downstream switch on a change in XOFF status for any virtual channel. The preferred XOFF signal is one or more Fibre Channel primitive containing the status for every virtual channel. Each primitive sends duplicate XOFF information, and always ends in negative running disparity.

### RELATED APPLICATION

This application is related to U.S. patent application entitled “Fibre Channel Switch,” Ser. No. ______, attorney docket number 3194, filed on even date herewith with inventors in common with the present application. This related application is hereby incorporated by reference.

### FIELD OF THE INVENTION

The present invention relates to flow control between devices and components during data communications. More particularly, the present invention relates to flow control within a Fibre Channel switch and between Fibre Channel switches over interswitch links.

### BACKGROUND OF THE INVENTION

Fibre Channel is a switched communications protocol that allows concurrent communication among servers, workstations, storage devices, peripherals, and other computing devices. Fibre Channel can be considered a channel-network hybrid, containing enough network features to provide the needed connectivity, distance and protocol multiplexing, and enough channel features to retain simplicity, repeatable performance and reliable delivery. Fibre Channel is capable of full-duplex transmission of frames at rates extending from 1 Gbps (gigabits per second) to 10 Gbps. It is also able to transport commands and data according to existing protocols such as Internet protocol (IP), Small Computer System Interface (SCSI), High Performance Parallel Interface (HIPPI) and Intelligent Peripheral Interface (IPI) over both optical fiber and copper cable.

In a typical usage, Fibre Channel is used to connect one or more computers or workstations together with one or more storage devices. In the language of Fibre Channel, each of these devices is considered a node. One node can be connected directly to another, or can be interconnected such as by means of a Fibre Channel fabric. The fabric can be a single Fibre Channel switch, or a group of switches acting together. Technically, the N_port (node ports) on each node are connected to F_ports (fabric ports) on the switch. Multiple Fibre Channel switches can be combined into a single fabric. The switches connect to each other via E-Port (Expansion Port) forming an interswitch link, or ISL.

Fibre Channel data is formatted into variable length data frames. Each frame starts with a start-of-frame (SOF) indicator and ends with a cyclical redundancy check (CRC) code for error detection and an end-of-frame indicator. In between are a 24-byte header and a variable-length data payload field that can range from 0 to 2112 bytes. The switch uses a routing table and the source and destination information found within the Fibre Channel frame header to route the Fibre Channel frames from one port to another. Routing tables can be shared between multiple switches in a fabric over an ISL, allowing one switch to know when a frame must be sent over the ISL to another switch in order to reach its destination port.

When Fibre Channel frames are sent between ports, credit-based flow control is used to prevent the recipient port from being overwhelmed. Two types of credit-based flow control are supported in Fibre Channel, end-to-end (EE_Credit) and buffer-to-buffer (BB_Credit). In EE_Credit, flow is managed between two end nodes, and intervening switch nodes do not participate.

In BB_Credit, flow control is maintained between each port, as is shown FIG. 1. Before the sending port 10 is allowed to send data to the receiving port 20, the receiving port 20 must communicate to the sending port 10 the size of its input buffer 22 in frames. The sending port 10 starts with this number of credits, and then decrements its credit count for each frame it transmits. Each time the receiving port 20 has successfully removed a frame from its buffer 22, it sends a credit back to the sending port 10. This allows the sending port 10 to increment its credit count. As long as the sending port 10 stops sending data when its credit count hits zero, it will never overflow the buffer 22 of the receiving port 20.

Although flow control should prevent the loss of Fibre Channel frames from buffer overflow, it does not prevent another condition known as blocking. Blocking occurs, in part, because Fibre Channel switches are required to deliver frames to any destination in the same order that they arrive from a source. One common approach to insure in order delivery in this context is to process frames in strict temporal order at the input or ingress side of a switch. This is accomplished by managing its input buffer as a first in, first out (FIFO) buffer.

Sometimes, however, a switch encounters a frame that cannot be delivered due to congestion at the destination port, as is shown in FIG. 2. In this switch 30, the frame 42 at the top of the input FIFO buffer 40 cannot be transmitted to port A 50 because this destination 50 is congested and not accepting more traffic. Because the buffer 40 is a first in, first out buffer, the top frame 42 will remain at the top of the buffer 40 until port A 50 becomes un-congested. This is true even though the next frame 44 in the FIFO 40 is destined for a port 52 that is not congested and could be transmitted immediately. This condition is referred to as head of line blocking.

Various techniques have been proposed to deal with the problem of head of line blocking. Scheduling algorithms, for instance, do not use true FIFOs. Rather, they search the input buffer 40 looking for matches between waiting data 4244 and available output ports 50-52. If the top frame 42 is destined for a busy port 50, the scheduling algorithm merely scans the buffer 40 for the first frame 44 that is destined for an available port 52. Such algorithms must take care to avoid sending Fibre Channel frames out of order. Another approach is to divide the input buffer 40 into separate buffers for each possible destination. However, this requires large amounts of memory and a good deal of complexity in large switches 30 having many possible destination ports 50-52. A third approach is the deferred queuing solution proposed by Inrange Technologies, the assignee of the present invention. This solution is described in the incorporated Fibre Channel Switch application.

Congestion and blocking are especially troublesome when the destination port is an E_Port 62 on a first switch 60 providing an ISL 65 to another switch 70, such as shown in FIG. 3. One reason that the E_Port 62 can become congested is that the input port 72 on the second switch 70 has filled up its input buffer 74. The BB_credit flow control between the switches 60, 70 prevents the first switch 60 from sending any more data to the second switch 70, thereby congesting the E_Port 62 connecting to the ISL. Often times the input buffer 74 on the second switch 70 becomes filled with frames 75 that are all destined for a single port C 76 on that second switch 70. Technically, this input buffer 74 is not suffering from head of line blocking since all frames 75 in the buffer 74 are destined to the same port C 76 and there are no frames 75 in the buffer 74 that are being blocked. However, this filled buffer 74 has congested the ISL 65, so that the first switch 60 cannot send any data to the second switch 70—including data at input port 64 that is destined for an un-congested port D 78 on the second switch 70. This situation can be referred to as unfair queuing, as data destined for port 76 has unfairly clogged the ISL 65 and prevented data from being sent across the link 65 to an available port 78.

The combined effects of head-of-line blocking and unfair queuing cause significant degradation in the performance of a Fibre Channel fabric. Accordingly, what is needed is an improved technique for flow control over an interswitch link that would avoid these problems.

### SUMMARY OF THE INVENTION

The foregoing needs are met, to a great extent, by the present invention, which provides flow control over each virtual channel in an interswitch link. Like other links linking two Fibre Channel ports, the interswitch link in the present invention utilizes BB_Credit flow control, which monitors the available space or credit in the credit memory of the downstream switch. The present invention includes additional flow control, however, since the BB_Credit flow control merely turns off and on the entire ISL—it does not provide any flow control mechanism that can turn off and on a single virtual channel in an interswitch link.

The present invention does this by defining a Fibre Channel primitive that can be sent from the downstream switch to the upstream switch. This primitive contains a map of the current state (XOFF or XON) of the logical channels in the ISL. In the preferred embodiment, each primitive provides a flow control status for eight logical channels. If more than eight logical channels are defined in the ISL, multiple primitives will be used. Consequently, XON/XOFF flow control is maintained for each virtual channel, while the entire ISL continues to utilize standard BB_Credit flow control.

The downstream switch maintains the current state of each of the virtual channels in an ISL. In the preferred embodiment, this state is determined by monitoring an XOFF mask. The XOFF mask is maintained by the ingress section of switch to indicate the flow control status of each of the possible egress ports in the downstream switch. It can be difficult to determine the flow control state of a logical channel simply by examining the XOFF mask. This is because the XOFF mask may maintain the status of five hundred and twelve egress ports or more, while the ISL has many fewer logical channels.

The present invention overcomes this issue by creating a mapping between the possible destination ports in the downstream switch and the logical channels on the ISL. This mapping is maintained at a logical level by defining a virtual input queue. The virtual input queue parallels the queues used in the upstream switch to provide queuing for the virtual channels. The virtual input queue then provides a mapping between these virtual channels and the egress ports on the downstream switch.

The virtual input queue is implemented in the preferred embodiment using a logical channel mask for each virtual channel. Each logical channel mask includes a single bit for each destination port on the downstream switch. A processor sets the logical channel mask for each virtual channel such that the mask represents all of the destination ports that are accessed over that virtual channel. The logical channel masks are then used to view the XOFF mask. If a destination port is included in the logical channel (that bit is set in the logical channel mask) and has a flow control status of XOFF (that bit is set in the XOFF mask), then the virtual channel will be assigned an XOFF status. Any single destination port that is assigned to a virtual channel will turn off the virtual channel when its status becomes XOFF on the XOFF mask.

### BRIEF DESCRIPTION OF THE DRAWINGS

FIG. 1 is a block diagram of two Fibre Channel ports transmitting data while using buffer-to-buffer flow control.

FIG. 2 is a block diagram showing a switch encountering head of line blocking.

FIG. 3 is a block diagram showing two switches communicating over an interswitch link and encountering unfair queuing.

FIG. 4 is a block diagram of one possible Fibre Channel switch in which the present invention can be utilized.

FIG. 5 is a block diagram showing the details of the port protocol device of the Fibre Channel switch shown in FIG. 4.

FIG. 6 is a block diagram showing the details of the memory controller and the ISL flow control module of the port protocol device shown in FIG. 5.

FIG. 7 is a block diagram of a Fibre Channel fabric in which the present invention can be utilized.

FIG. 8 is a block diagram showing the queuing utilized in an upstream switch and a downstream switch communicating over an interswitch link.

FIG. 9 is a block diagram showing XOFF flow control between the ingress memory subsystem and the egress memory subsystem in the switch of FIG. 4.

FIG. 10 is a block diagram showing backplane credit flow control between the ingress memory subsystem and the egress memory subsystem in the switch of FIG. 4.

FIG. 11 is a block diagram showing flow control between the ingress memory subsystem and the protocol interface module in the switch of FIG. 4.

FIG. 12 is a block diagram showing flow control between the fabric interface module and the egress memory subsystem in the switch of FIG. 4.

FIG. 13 is a block diagram showing flow control between the fabric interface module and the protocol interface module in the switch of FIG. 4.

FIG. 14 is a block diagram showing cell credit flow control of the present invention as maintained by the protocol interface module in the switch of FIG. 4.

FIG. 15 is a block diagram showing flow control of the present invention between a downstream switch and an upstream switch over an interswitch link.

FIG. 16 is a block diagram of a flow control primitive used in the flow control scheme of FIG. 15.

FIG. 17 is a block diagram of an F class frame used to establish virtual channels over an interswitch link in the present invention.

### DETAILED DESCRIPTION OF THE INVENTION

1. Switch 100

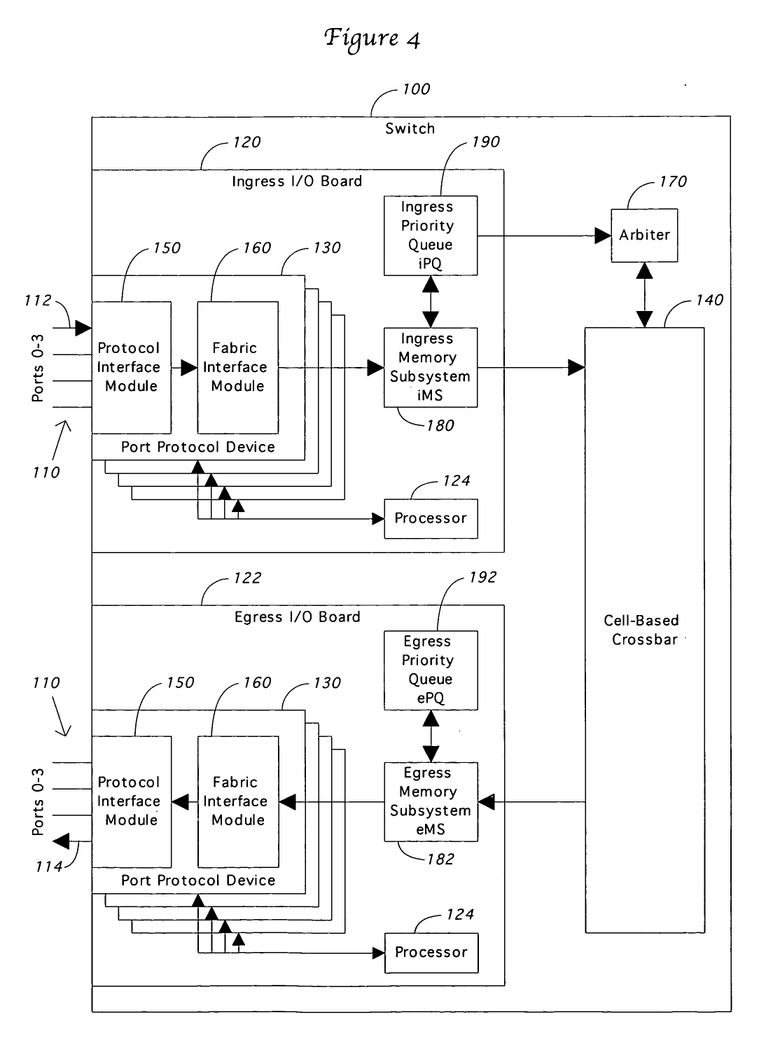

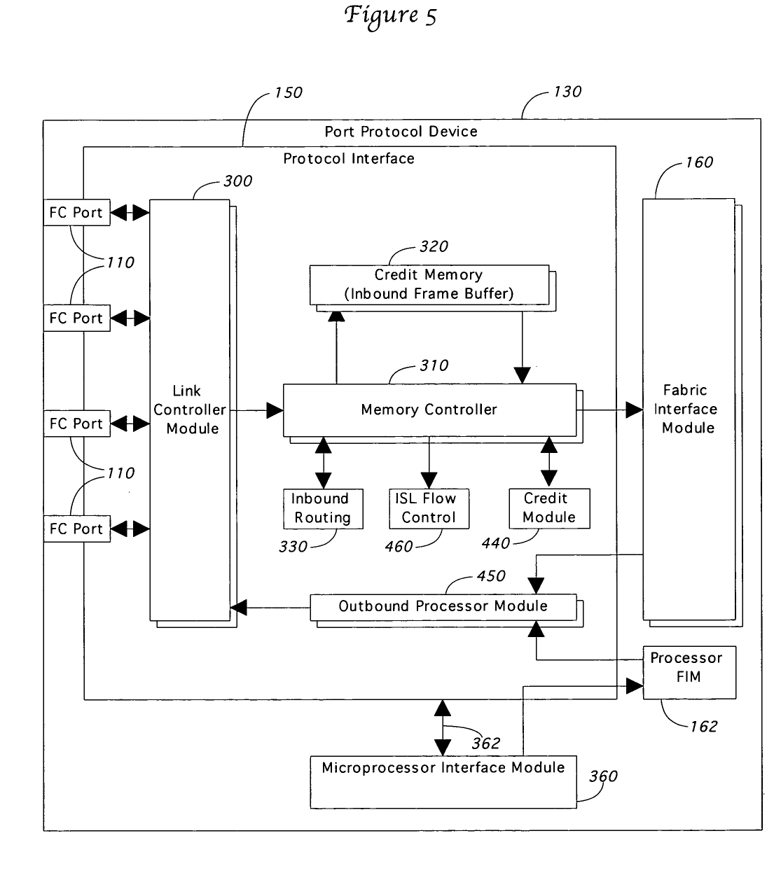

The present invention is best understood after examining the major components of a Fibre Channel switch, such as switch 100 shown in FIG. 4. The components shown in FIG. 4 are helpful in understanding the applicant's preferred embodiment, but persons of ordinary skill will understand that the present invention can be incorporated in switches of different construction, configuration, or port counts.

Switch 100 is a director class Fibre Channel switch having a plurality of Fibre Channel ports 110. The ports 110 are physically located on one or more I/O boards inside of switch 100. Although FIG. 4 shows only two I/O boards, namely ingress board 120 and egress board 122, a director class switch 100 would contain eight or more such boards. The preferred embodiment described in the application can contain thirty-two such I/O boards 120, 122. Each board 120, 122 contains a microprocessor 124 that, along with its RAM and flash memory (not shown), is responsible for controlling and monitoring the other components on the boards 120, 122 and for handling communication between the boards 120, 122.

In the preferred embodiment, each board 120, 122 also contains four port protocol devices (or PPDs) 130. These PPDs 130 can take a variety of known forms, including an ASIC, an FPGA, a daughter card, or even a plurality of chips found directly on the boards 120, 122. In the preferred embodiment, the PPDs 130 are ASICs, and can be referred to as the FCP ASICs, since they are primarily designed to handle Fibre Channel protocol data. Each PPD 130 manages and controls four ports 110. This means that each I/O board 120, 122 in the preferred embodiment contains sixteen Fibre Channel ports 110.

The I/O boards 120, 122 are connected to one or more crossbars 140 designed to establish a switched communication path between two ports 110. Although only a single crossbar 140 is shown, the preferred embodiment uses four or more crossbar devices 140 working together. In the preferred embodiment, crossbar 140 is cell-based, meaning that it is designed to switch small, fixed-size cells of data. This is true even though the overall switch 100 is designed to switch variable length Fibre Channel frames.

The Fibre Channel frames are received on a port, such as input port 112, and are processed by the port protocol device 130 connected to that port 112. The PPD 130 contains two major logical sections, namely a protocol interface module 150 and a fabric interface module 160. The protocol interface module 150 receives Fibre Channel frames from the ports 110 and stores them in temporary buffer memory. The protocol interface module 150 also examines the frame header for its destination ID and determines the appropriate output or egress port 114 for that frame. The frames are then submitted to the fabric interface module 160, which segments the variable-length Fibre Channel frames into fixed-length cells acceptable to crossbar 140.

The fabric interface module 160 then transmits the cells to an ingress memory subsystem (iMS) 180. A single iMS 180 handles all frames received on the I/O board 120, regardless of the port 110 or PPD 130 on which the frame was received.

When the ingress memory subsystem 180 receives the cells that make up a particular Fibre Channel frame, it treats that collection of cells as a variable length packet. The iMS 180 assigns this packet a packet ID (or “PID”) that indicates the cell buffer address in the iMS 180 where the packet is stored. The PID and the packet length is then passed on to the ingress Priority Queue (iPQ) 190, which organizes the packets in iMS 180 into one or more queues, and submits those packets to crossbar 140. Before submitting a packet to crossbar 140, the iPQ 190 submits a “bid” to arbiter 170. When the arbiter 170 receives the bid, it configures the appropriate connection through crossbar 140, and then grants access to that connection to the iPQ 190. The packet length is used to ensure that the connection is maintained until the entire packet has been transmitted through the crossbar 140, although the connection can be terminated early.

A single arbiter 170 can manage four different crossbars 140. The arbiter 170 handles multiple simultaneous bids from all iPQs 190 in the switch 100, and can grant multiple simultaneous connections through crossbar 140. The arbiter 170 also handles conflicting bids, ensuring that no output port 114 receives data from more than one input port 112 at a time.

The output or egress memory subsystem (eMS) 182 receives the data cells comprising the packet from the crossbar 140, and passes a packet ID to an egress priority queue (ePQ) 192. The egress priority queue 192 provides scheduling, traffic management, and queuing for communication between egress memory subsystem 182 and the PPD 130 in egress I/O board 122. When directed to do so by the ePQ 192, the eMS 182 transmits the cells comprising the Fibre Channel frame to the egress portion of PPD 130. The fabric interface module 160 then reassembles the data cells and presents the resulting Fibre Channel frame to the protocol interface module 150. The protocol interface module 150 stores the frame in its buffer, and then outputs the frame through output port 114.

In the preferred embodiment, crossbar 140 and the related components are part of a commercially available cell-based switch chipset, such as the nPX8005 or “Cyclone” switch fabric manufactured by Applied Micro Circuits Corporation of San Diego, Calif. More particularly, in the preferred embodiment, the crossbar 140 is the AMCC S8705 Crossbar product, the arbiter 170 is the AMCC S8605 Arbiter, the iPQ 190 and ePQ 192 are AMCC S8505 Priority Queues, and the iMS 180 and eMS 182 are AMCC S8905 Memory Subsystems, all manufactured by Applied Micro Circuits Corporation.

2. Port Protocol Device 130

a) Link Controller Module 300

FIG. 5 shows the components of one of the four port protocol devices 130 found on each of the I/O Boards 120, 122. As explained above, incoming Fibre Channel frames are received over a port 110 by the protocol interface 150. A link controller module (LCM) 300 in the protocol interface 150 receives the Fibre Channel frames and submits them to the memory controller module 310. One of the primary jobs of the link controller module 300 is to compress the start of frame (SOF) and end of frame (EOF) codes found in each Fibre Channel frame. By compressing these codes, space is created for status and routing information that must be transmitted along with the data within the switch 100. More specifically, as each frame passes through PPD 130, the PPD 130 generates information about the frame's port speed, its priority value, the internal switch destination address (or SDA) for the source port 112 and the destination port 114, and various error indicators. This information is added to the SOF and EOF in the space made by the LCM 300. This “extended header” stays with the frame as it traverses through the switch 100, and is replaced with the original SOF and EOF as the frame leaves the switch 100.

The LCM 300 uses a SERDES chip (such as the Gigablaze SERDES available from LSI Logic Corporation, Milpitas, Calif.) to convert between the serial data used by the port 110 and the 10-bit parallel data used in the rest of the protocol interface 150. The LCM 300 performs all low-level link-related functions, including clock conversion, idle detection and removal, and link synchronization. The LCM 300 also performs arbitrated loop functions, checks frame CRC and length, and counts errors.

b) Memory Controller Module 310

The memory controller module 310 is responsible for storing the incoming data frame on the inbound frame buffer memory 320. Each port 110 on the PPD 130 is allocated a separate portion of the buffer 320. Alternatively, each port 110 could be given a separate physical buffer 320. This buffer 320 is also known as the credit memory, since the BB_Credit flow control between switch 100 and the upstream device is based upon the size or credits of this memory 320. The memory controller 310 identifies new Fibre Channel frames arriving in credit memory 320, and shares the frame's destination ID and its location in credit memory 320 with the inbound routing module 330.

The routing module 330 of the present invention examines the destination ID found in the frame header of the frames and determines the switch destination address (SDA) in switch 100 for the appropriate destination port 114. The router 330 is also capable of routing frames to the SDA associated with one of the microprocessors 124 in switch 100. In the preferred embodiment, the SDA is a ten-bit address that uniquely identifies every port 110 and processor 124 in switch 100. A single routing module 330 handles all of the routing for the PPD 130. The routing module 330 then provides the routing information to the memory controller 310.

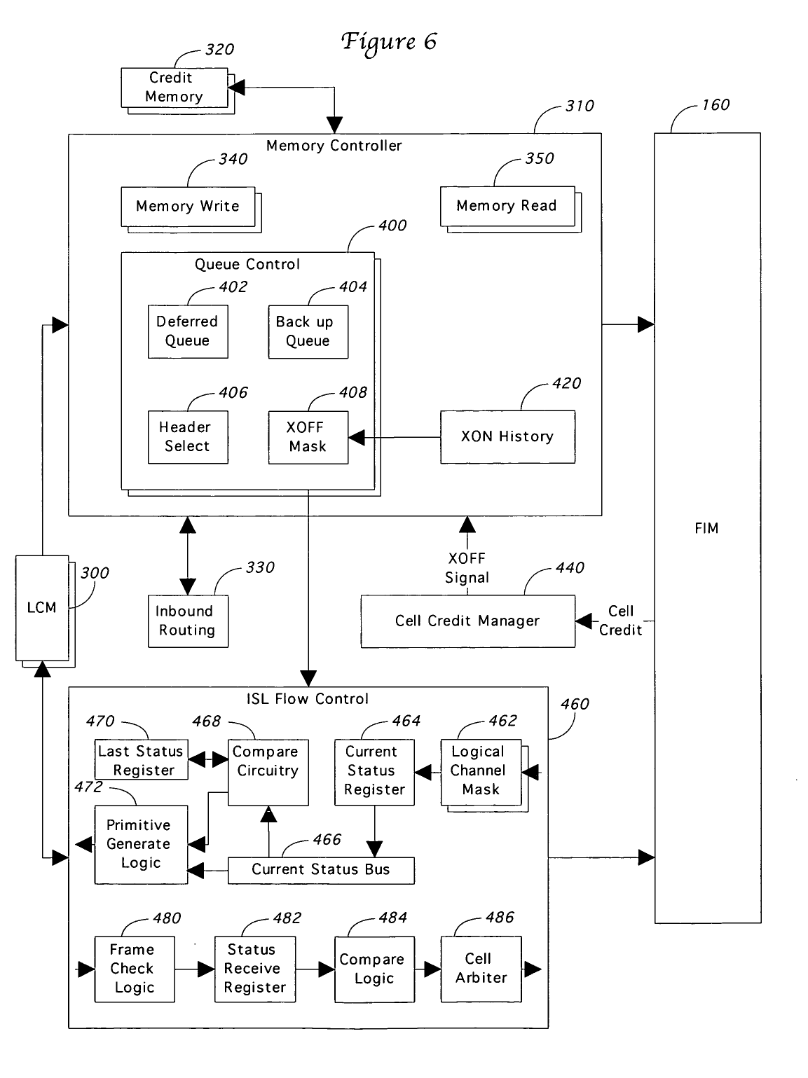

As shown in FIG. 6, the memory controller 310 consists of four primary components, namely a memory write module 340, a memory read module 350, a queue control module 400, and an XON history register 420. A separate write module 340, read module 350, and queue control module 400 exist for each of the four ports 110 on the PPD 130. A single XON history register 420 serves all four ports 110. The memory write module 340 handles all aspects of writing data to the credit memory 320. The memory read module 350 is responsible for reading the data frames out of memory 320 and providing the frame to the fabric interface module 160.

c) Queue Control Module 400

The queue control module 400 stores the routing results received from the inbound routing module 330. When the credit memory 320 contains multiple frames, the queue control module 400 decides which frame should leave the memory 320 next. In doing so, the queue module 400 utilizes procedures that avoid head-of-line blocking.

The queue control module 400 has four primary components, namely the deferred queue 402, the backup queue 404, the header select logic 406, and the XOFF mask 408. These components work in conjunction with the XON History register 420 and the cell credit manager or credit module 440 to control ingress queuing and to assist in managing flow control within switch 100. The deferred queue 402 stores the frame headers and locations in buffer memory 320 for frames waiting to be sent to a destination port 114 that is currently busy. The backup queue 404 stores the frame headers and buffer locations for frames that arrive at the input port 112 while the deferred queue 402 is sending deferred frames to their destination. The header select logic 406 determines the state of the queue control module 400, and uses this determination to select the next frame in credit memory 320 to be submitted to the FIM 160. To do this, the header select logic 406 supplies to the memory read module 350 a valid buffer address containing the next frame to be sent. The functioning of the backup queue 404, the deferred queue 402, and the header select logic 406 are described in more detail in the incorporated “Fibre Channel Switch” application.

The XOFF mask 408 contains a congestion status bit for each port 110 within the switch 100. In one embodiment of the switch 100, there are five hundred and twelve physical ports 110 and thirty-two microprocessors 124 that can serve as a destination for a frame. Hence, the XOFF mask 408 uses a 544 by 1 look up table to store the “XOFF” status of each destination. If a bit in XOFF mask 408 is set, the port 110 corresponding to that bit is busy and cannot receive any frames. In the preferred embodiment, the XOFF mask 408 returns a status for a destination by first receiving the SDA for that port 110 or microprocessor 124. The look up table is examined for that SDA, and if the corresponding bit is set, the XOFF mask 408 asserts a “defer” signal which indicates to the rest of the queue control module 400 that the selected port 110 or processor 124 is busy.

The XON history register 420 is used to record the history of the XON status of all destinations in the switch. Under the procedure established for deferred queuing, the XOFF mask 408 cannot be updated with an XON event when the queue control 400 is servicing deferred frames in the deferred queue 402. During that time, whenever a port 110 changes status from XOFF to XON, the cell credit manager 440 updates the XON history register 420 rather than the XOFF mask 408. When the reset signal is active, the entire content of the XON history register 420 is transferred to the XOFF mask 408. Registers within the XON history register 420 containing a zero will cause corresponding registers within the XOFF mask 408 to be reset. The dual register setup allows for XOFFs to be written at any time the cell credit manager 440 requires traffic to be halted, and causes XONs to be applied only when the logic within the header select 406 allows for changes in the XON values. While a separate queue control module 400 and its associated XOFF mask 408 is necessary for each port in the PPD 130, only one XON history register 420 is necessary to service all four ports in the PPD 130. The XON history register 420 and the XOFF mask 408 are updated through the credit module 440 as described in more detail below.

The XOFF signal of the credit module 440 is a composite of cell credit availability maintained by the credit module 440 and output channel XOFF signals. The credit module 440 is described in more detail below.

d) Fabric Interface Module 160

Referring to FIGS. 4-6, when a Fibre Channel frame is ready to be submitted to the ingress memory subsystem 180 of I/O board 120, the queue control 400 passes the frame's routed header and pointer to the memory read portion 350. This read module 350 then takes the frame from the credit memory 320 and provides it to the fabric interface module 160. The fabric interface module 160 converts the variable-length Fibre Channel frames received from the protocol interface 150 into fixed-sized data cells acceptable to the cell-based crossbar 140. Each cell is constructed with a specially configured cell header appropriate to the cell-based switch fabric. When using the Cyclone switch fabric of Applied Micro Circuits Corporation, the cell header includes a starting sync character, the switch destination address of the egress port 114 and a priority assignment from the inbound routing module 330, a flow control field and ready bit, an ingress class of service assignment, a packet length field, and a start-of-packet and end-of-packet identifier.

When necessary, the preferred embodiment of the fabric interface 160 creates fill data to compensate for the speed difference between the memory controller 310 output data rate and the ingress data rate of the cell-based crossbar 140. This process is described in more detail in the incorporated “Fibre Channel Switch” application.

Egress data cells are received from the crossbar 140 and stored in the egress memory subsystem 182. When these cells leave the eMS 182, they enter the egress portion of the fabric interface module 160. The FIM 160 then examines the cell headers, removes fill data, and concatenates the cell payloads to re-construct Fibre Channel frames with extended SOF/EOF codes. If necessary, the FIM 160 uses a small buffer to smooth gaps within frames caused by cell header and fill data removal.

In the preferred embodiment, there are multiple links between each PPD 130 and the iMS 180. Each separate link uses a separate FIM 160. Preferably, each port 110 on the PPD 130 is given a separate link to the iMS 180, and therefore each port 110 is assigned a separate FIM 160.

e) Outbound Processor Module 450

The FIM 160 then submits the frames to the outbound processor module (OPM) 450. A separate OPM 450 is used for each port 110 on the PPD 130. The outbound processor module 450 checks each frame's CRC, and handles the necessary buffering between the fabric interface 160 and the ports 110 to account for their different data transfer rates. The primary job of the outbound processor modules 450 is to handle data frames received from the cell-based crossbar 140 that are destined for one of the Fibre Channel ports 110. This data is submitted to the link controller module 300, which replaces the extended SOF/EOF codes with standard Fibre Channel SOF/EOF characters, performs 8b/10b encoding, and sends data frames through its SERDES to the Fibre Channel port 110.

The components of the PPD 130 can communicate with the microprocessor 124 on the I/O board 120, 122 through the microprocessor interface module (MIM) 360. Through the microprocessor interface 360, the microprocessor 124 can read and write registers on the PPD 130 and receive interrupts from the PPDs 130. This communication occurs over a microprocessor communication path 362. The outbound processor module 450 works with the microprocessor interface module 360 to allow the microprocessor 124 to communicate to the ports 110 and across the crossbar switch fabric 140 using frame based communication. The OPM 450 is responsible for detecting data frames received from the fabric interface module 160 that are directed toward the microprocessor 124. These frames are submitted to the microprocessor interface module 360. The OPM 450 can also receive communications that the processor 124 submits to the ports 110. The OPM 450 delivers these frames to the link controller module 300, which then communicates the frames through its associated port 110. When the microprocessor 124 is sending frames to the ports 110, the OPM 450 buffers the frames received from the fabric interface module 160 for the port 110.

Only one data path is necessary on each I/O board 120, 122 for communications over the crossbar fabric 140 to the microprocessor. Hence, only one outbound processor module 450 per board 120, 122 needs to be programmed to receive fabric-to-microprocessor communications in this manner. Although any OPM 450 could be selected for this communication, the preferred embodiment used the OPM 450 handling communications on the third port 110 (numbered 0-3) on the third PPD 130 (numbered 0-3) on each board 120, 122. In the embodiment that uses eight classes of service for each port 110 (numbered 0-7), microprocessor communication is actually directed to class of service 7, port 3, PPD 3. The OPM 450 handling this PPD and port is the only OPM 450 configured to detect microprocessor-directed communication and to communicate such data directly to the microprocessor interface module 360.

As explained above, a separate communication path between the PPD 130 and the eMS 182 is generally provided for each port 110, and each communication path has a dedicated FIM 160 associated with it. This means that, since each OPM 450 serves a single port 110, each OPM 450 communicates with a single FIM 160. The third OPM 450 is different, however, since it also handles fabric-to-microprocessor communication. In the preferred embodiment, an additional path between the eMS 182 and PPD 130 is provided for such communication. This means that this third OPM is a dual-link OPM 450, receiving and buffering frames from two fabric interface modules 160, 162. This third OPM 450 also has four buffers, two for fabric-to-port data and two for fabric-to-microprocessor data (one for each FIM 160, 162).

In an alternative embodiment, the ports 110 might require additional bandwidth to the iMS 180, such as where the ports 110 can communicate at four gigabits per second. In these embodiments, multiple links can be made between each port 110 and the iMS 180, each communication path having a separate FIM 160. In these embodiments, all OPMs 450 will communicate with multiple FIMs 160, and will have at least one buffer for each FIM 160 connection.

3. Fabric 200

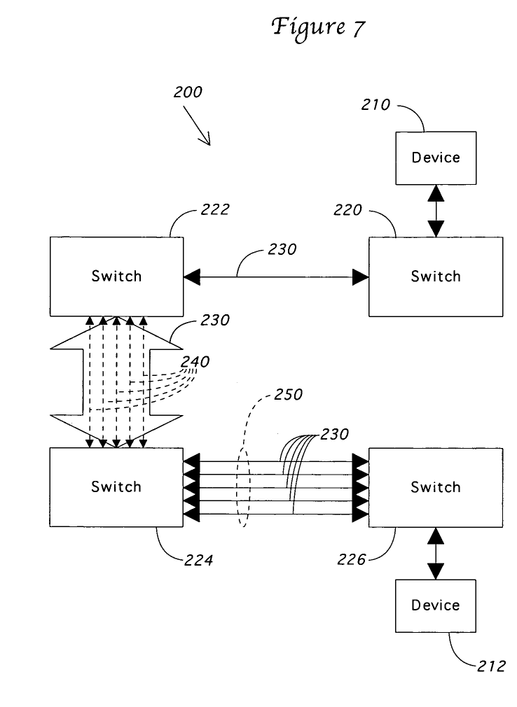

FIG. 7 shows two devices 210, 212 connected together over a fabric 200 consisting of four switches 220-228. Each of these switches 220-228 is connected together using one or more interswitch links 230. Switch 220 connects to switch 222 through a single ISL 230. Likewise, the connection between switch 222 and switch 224 uses a single ISL 230 as well. This ISL 230, however, is subdivided into a plurality of logical or virtual channels 240. The channels 240 can be used to shape traffic flow over the ISL 230. In the preferred embodiment, the virtual channels 240 are also used to enhance flow control over the interswitch link 230.

The inbound routing module 330 in the preferred embodiment allows for the convenient assignment of data traffic to a particular virtual channel 240 based upon the source and destination of the traffic. For instance, traffic between the two devices 210, 212 can be assigned to a different logical channel 240 than all other traffic between the two switches 222, 224. An example routing system capable of performing such an assignment is described in more detail in the incorporated “Fibre Channel Switch” application. The assignment of traffic to a virtual channel 240 can be based upon individual pairs of source devices 210 and destination devices 212, or it can be based on groups of source-destination pairs.

In the preferred embodiment, the inbound routing module 330 assigns a priority to an incoming frame at the same time the frame is assigned a switch destination address for the egress port 114. The assigned priority for a frame heading over an ISL 230 will then be used to assign the frame to a logical channel 240. In fact, the preferred embodiment uses the unaltered priority value as the logical channel 240 assignment for a data frame heading over an interswitch link 230.

Every ISL 230 in fabric 200 can be divided into separate virtual channels 240, with the assignment of traffic to a particular virtual channel 240 being made independently at each switch 220-226 submitting traffic to an ISL 230. For instance, assuming that each ISL 230 is divided into eight virtual channels 240, the different channels 240 could be numbered 0-7. The traffic flow from device 210 to device 212 could be assigned by switch 220 to virtual channel 0 on the ISL 230 linking switch 220 and 222, but could then be assigned virtual channel 6 by switch 222 on the ISL 230 linking switch 222 and 224.

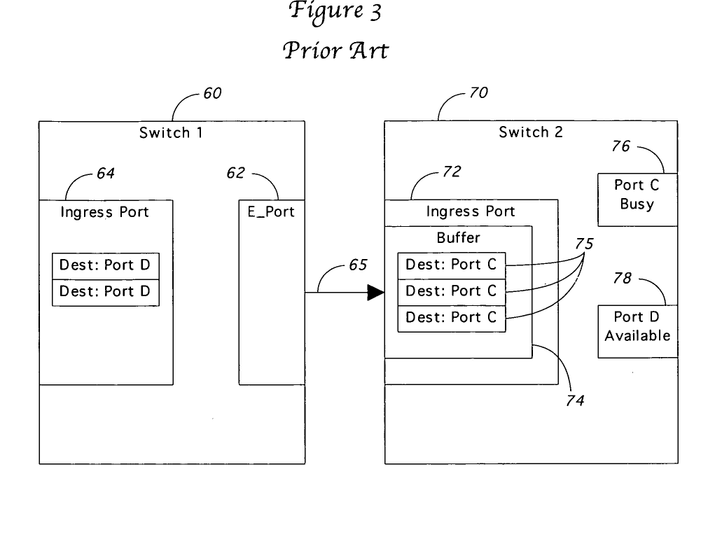

By managing flow control over the ISL 230 on a virtual channel 240 basis, congestion on the other virtual channels 240 in the ISL 230 would not affect the traffic between the two devices 210, 212. This avoids the situation shown in FIG. 3. Flows that could negatively impact traffic on an interswitch link 240 can be segregated from those that can fully utilize network resources, which will improve overall performance and utilization while delivering guaranteed service levels to all flows. In other words, the use of virtual channels 240 allows the separation of traffic into distinct class of service levels. Hence, each virtual channel 240 is sometimes referred to as a distinct class of service or CoS.

Switch 224 and switch 226 are interconnected using five different interswitch links 230. It can be extremely useful to group these different ISL 230 into a single ISL group 250. The ISL group 250 can then appear as a single large bandwidth link between the two switches 224 and 226 during the configuration and maintenance of the fabric 200. In addition, defining an ISL group 250 allows the switches 224 and 226 to more effectively balance the traffic load across the physical interswitch links 230 that make up the ISL group 250.

4. Queues

a) Class of Service Queue 280

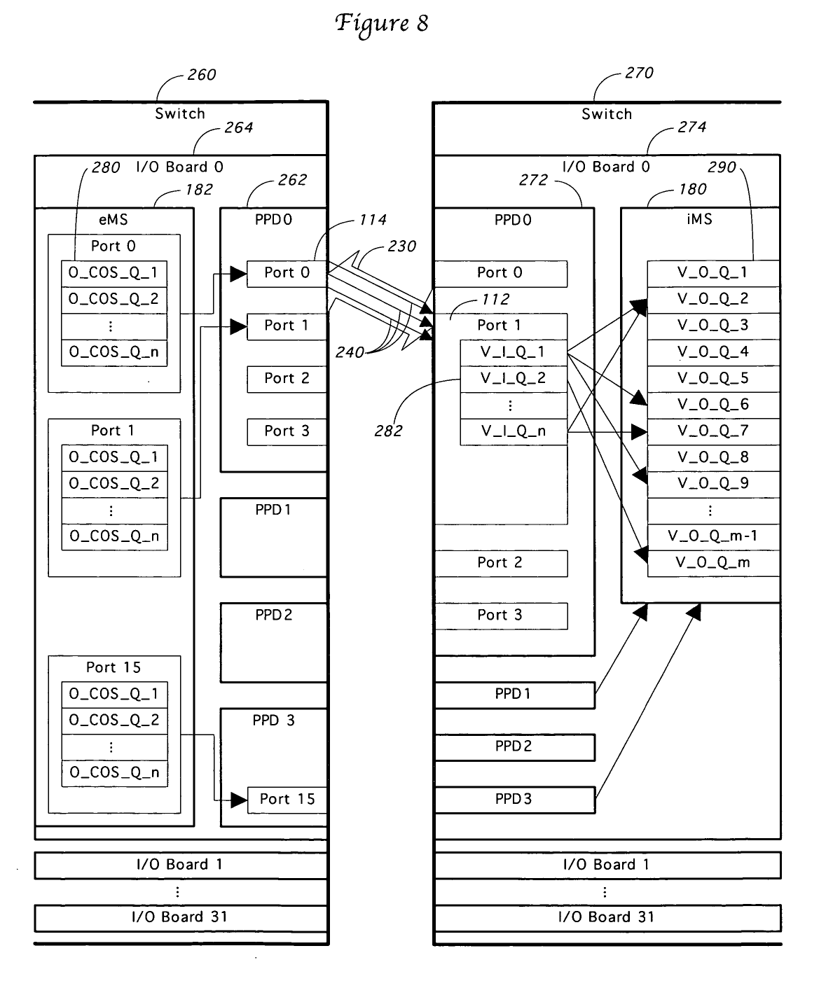

Flow control over the logical channels 240 of the present invention is made possible through the various queues that are used to organize and control data flow between two switches and within a switch. FIG. 8 shows two switches 260, 270 that are communicating over an interswitch link 230. The ISL 230 connects an egress port 114 on upstream switch 260 with an ingress port 112 on downstream switch 270. The egress port 114 is located on the first PPD 262 (labeled PPD 0) on the first I/O Board 264 (labeled I/O Board 0) on switch 260. This I/O board 264 contains a total of four PPDs 130, each containing four ports 110. This means I/O board 264 has a total of sixteen ports 110, numbered 0 through 15. In FIG. 8, switch 260 contains thirty-one other I/O boards 120, 122, meaning the switch 260 has a total of five hundred and twelve ports 110. This particular configuration of I/O Boards 120, 122, PPDs 130, and ports 110 is for exemplary purposes only, and other configurations would clearly be within the scope of the present invention.

I/O Board 264 has a single egress memory subsystem 182 to hold all of the data received from the crossbar 140 (not shown) for its sixteen ports 110. The data in eMS 182 is controlled by the egress priority queue 192 (also not shown). In the preferred embodiment, the ePQ 192 maintains the data in the eMS 182 in a plurality of output class of service queues (O_COS_Q) 280. Data for each port 110 on the I/O Board 264 is kept in a total of “n” O_COS queues, with the number n reflecting the number of virtual channels 240 defined to exist with the ISL 230. When cells are received from the crossbar 140, the eMS 182 and ePQ 192 add the cell to the appropriate O_COS_Q 280 based on the destination SDA and priority value assigned to the cell. This information was placed in the cell header as the cell was created by the ingress FIM 160.

The output class of service queues 280 for a particular egress port 114 can be serviced according to any of a great variety of traffic shaping algorithms. For instance, the queues 280 can be handled in a round robin fashion, with each queue 280 given an equal weight. Alternatively, the weight of each queue 280 in the round robin algorithm can be skewed if a certain flow is to be given priority over another. It is even possible to give one or more queues 280 absolute priority over the other queues 280 servicing a port 110. The cells are then removed from the O_COS_Q 280 and are submitted to the PPD 262 for the egress port 114, which converts the cells back into a Fibre Channel frame and sends it across the ISL 230 to the downstream switch 270.

b) Virtual Output Queue 290

The frame enters switch 270 over the ISL 230 through ingress port 112. This ingress port 112 is actually the second port (labeled port 1) found on the first PPD 272 (labeled PPD 0) on the first I/O Board 274 (labeled I/O Board 0) on switch 270. Like the I/O board 264 on switch 260, this I/O board 274 contains a total of four PPDs 130, with each PPD 130 containing four ports 110. With a total of thirty-two I/O boards 120, 122, switch 270 has the same five hundred and twelve ports as switch 260.

When the frame is received at port 112, it is placed in credit memory 320. The D_ID of the frame is examined, and the frame is queued and a routing determination is made as described above. Assuming that the destination port on switch 270 is not XOFFed according to the XOFF mask 408 servicing input port 112, the frame will be subdivided into cells and forwarded to the ingress memory subsystem 180.

The iMS 180 is organized and controlled by the ingress priority queue 190, which is responsible for ensuring in-order delivery of data cells and packets. To accomplish this, the iPQ 190 organizes the data in its iMS 180 into a number (“m”) of different virtual output queues (V_O_Qs) 290. To avoid head-of-line blocking, a separate V_O_Q 290 is established for every destination within the switch 270. In switch 270, this means that there are at least five hundred forty-four V_O_Qs 290 (five hundred twelve physical ports 110 and thirty-two microprocessors 124) in iMS 180. The iMS 180 places incoming data on the appropriate V_O_Q 290 according to the switch destination address assigned to that data.

When using the AMCC Cyclone chipset, the iPQ 190 can configure up to 1024 V_O_Qs 290. In an alternative embodiment of the virtual output queue structure in iMS 180, all 1024 available queues 290 are used in a five hundred twelve port switch 270, with two V_O_Qs 290 being assigned to each port 110. One of these V_O_Qs 290 is dedicated to carrying real data destined to be transmitted out the designated port 110. The other V_O_Q 290 for the port 110 is dedicated to carrying traffic destined for the microprocessor 124 at that port 110. In this environment, the V_O_Qs 290 that are assigned to each port can be considered two different class of service queues for that port, with a separate class of service for each type of traffic. The FIM 160 places an indication as to which class of service should be provided to an individual cell in a field found in the cell header, with one class of service for real data and another for internal microprocessor communications. In this way, the present invention is able to separate internal messages and other microprocessor based communication from real data traffic. This is done without requiring a separate data network or using additional crossbars 140 dedicated to internal messaging traffic. And since the two V_O_Qs 290 for each port are maintained separately, real data traffic congestion on a port 110 does not affect the ability to send messages to the port, and vice versa.

Data in the V_O_Qs 290 is handled like the data in O_COS_Qs 280, such as by using round robin servicing. When data is removed from a V_O_Q 290, it is submitted to the crossbar 140 and provided to an eMS 182 on the switch 270.

c) Virtual Input Queue 282

FIG. 8 also shows a virtual input queue structure 282 within each ingress port 112 in downstream switch 270. Each of these V_I_Qs 282 corresponds to one of the virtual channels 240 on the ISL 230, which in turn corresponds to one of the O_COS_Qs 280 on the upstream switch. In other words, a frame that is assigned a class of service level of “2” will be assigned to O_COS_Q_{—}2 at eMS 280, will travel to downstream switch 270 over virtual channel “2,” and will be associated with virtual input queue “2” at the ingress port 112.

By assigning frames to a V_I_Q 282 in ingress port 112, the downstream switch 270 can identify which O_COS_Q 280 in switch 260 was assigned to the frame. As a result, if a particular data frame encounters a congested port within the downstream switch 270, the switch 270 is able to communicate that congestion to the upstream switch by performing flow control for the virtual channel 240 assigned to that O_COS_Q 280.

For this to function properly, the downstream switch 270 must provide a signal mapping such that any V_O_Q 290 that encounters congestion will signal the appropriate V_I_Q 282, which in turn will signal the upstream switch 260 to XOFF the corresponding O_COS_Q 280. The logical channel mask 462 handles the mapping between ports in the downstream switch 270 and virtual channels 240 on the ISL 230, as is described in more detail below.

5. Flow Control in Switch

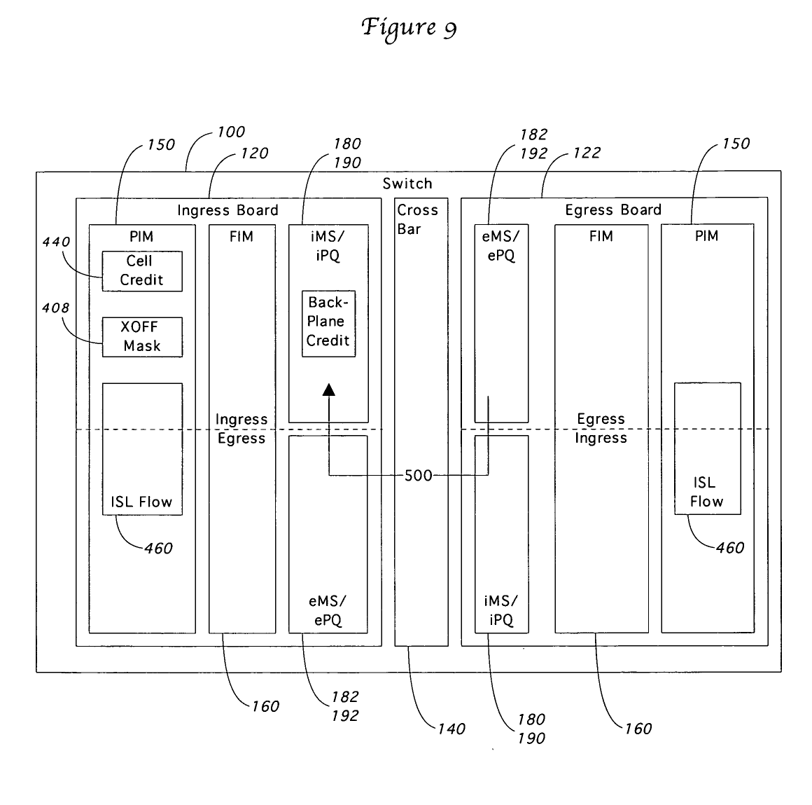

The cell-based switch fabric used in the preferred embodiment of the present invention can be considered to include the memory subsystems 180, 182, the priority queues 190, 192, the cell-based crossbar 140, and the arbiter 170. As described above, these elements can be obtained commercially from companies such as Applied Micro Circuits Corporation. This switch fabric utilizes a variety of flow control mechanisms to prevent internal buffer overflows, to control the flow of cells into the cell-based switch fabric, and to receive flow control instructions to stop cells from exiting the switch fabric. These flow control mechanisms, along with the other methods of flow control existing within switch 100, are shown in FIGS. 9-15.

a) Internal Flow Control Between iMS 180 and eMS 182

i) Routing, Urgent, and Emergency XOFF 500

XOFF internal flow control within the cell-based switch fabric is shown as communication 500 in FIG. 9. This flow control serves to stop data cells from being sent from iMS 180 to eMS 182 over the crossbar 140 in situations where the eMS 182 or one of the O_COS_Qs 280 in the eMS 182 is becoming full. If there were no flow control, congestion at an egress port 114 would prevent data in the port's associated O_COS_Qs 280 from exiting the switch 100. If the iMS 180 were allowed to keep sending data to these queues 280, eMS 182 would overflow and data would be lost.

This flow control works as follows. When cell occupancy of an O_COS_Q 280 reaches a threshold, an XOFF signal is generated internal to the switch fabric to stop transmission of data from the iMS 180 to these O_COS_Qs 280. The preferred Cyclone switch fabric uses three different thresholds, namely a routine threshold, an urgent threshold, and an emergency threshold. Each threshold creates a corresponding type of XOFF signal to the iMS 180.

Unfortunately, since the V_O_Qs 290 in iMS 180 are not organized into the individual class of services for each possible output port 114, the XOFF signal generated by the eMS 182 cannot simply turn off data for a single O_COS_Q 280. In fact, due to the manner in which the cell-based fabric addresses individual ports, the XOFF signal is not even specific to a single congested port 110. Rather, in the case of the routine XOFF signal, the iMS 180 responds by stopping all cell traffic to the group of four ports 110 found on the PPD 130 that contains the congested egress port 114. Urgent and Emergency XOFF signals cause the iMS 180 and Arbiter 170 to stop all cell traffic to the effected egress I/O board 122. In the case of routine and urgent XOFF signals, the eMS 182 is able to accept additional packets of data before the iMS 180 stops sending data. Emergency XOFF signals mean that new packets arriving at the eMS 182 will be discarded.

ii) Backplane Credits 510

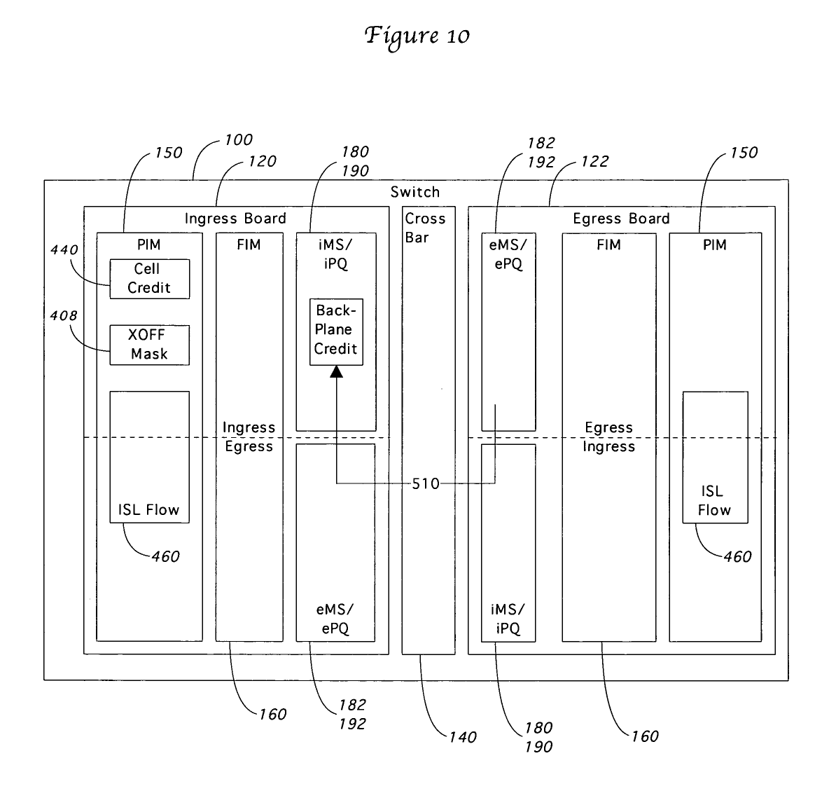

The iPQ 190 also uses a backplane credit flow control 510 (shown in FIG. 10) to manage the traffic from the iMS 180 to the different egress memory subsystems 182 more granularly than the XOFF signals 500 described above. For every packet submitted to an egress port 114, the iPQ 190 decrements its “backplane” credit count for that port 114. When the packet is transmitted out of the eMS 182, a backplane credit is returned to the iPQ 190. If a particular O_COS_Q 280 cannot submit data to an ISL 230 (such as when the associated virtual channel 240 has an XOFF status), credits will not be returned to the iPQ 190 that submitted those packets. Eventually, the iPQ 190 will run out of credits for that egress port 114, and will stop making bids to the arbiter 170 for these packets. These packets will then be held in the iMS 180.

Note that even though only a single O_COS_Q 280 is not sending data, the iPQ 190 only maintains credits on an port 110 basis, not a class of service basis. Thus, the effected iPQ 190 will stop sending all data to the port 114, including data with a different class of service that could be transmitted over the port 114. In addition, since the iPQ 190 services an entire I/O board 120, all traffic to that egress port 114 from any of the ports 110 on that board 120 is stopped. Other iPQs 190 on other I/O boards 120, 122 can continue sending packets to the same egress port 114 as long as those other iPQs 190 have backplane credits for that port 114.

Thus, the backplane credit system 510 can provide some internal switch flow control from ingress to egress on the basis of a virtual channel 240, but it is inconsistent. If two ingress ports 112 on two separate I/O boards 120, 122 are each sending data to different virtual channels 240 on the same ISL 230, the use of backplane credits will flow control those channels 240 differently. One of those virtual channels 240 might have an XOFF condition. Packets to that O_COS_Q 280 will back up, and backplane credits will not be returned. The lack of backplane credits will cause the iPQ 190 sending to the XOFFed virtual channel 240 to stop sending data. Assuming the other virtual channel does not have an XOFF condition, credits from its O_COS_Q 280 to the other iPQ 190 will continue, and data will flow through that channel 240. However, if the two ingress ports 112 sending to the two virtual channels 240 utilize the same iPQ 190, the lack of returned backplane credits from the XOFFed O_COS_Q 280 will stop traffic to all virtual channels 240 on the ISL 230.

b) Input to Fabric Flow Control 520

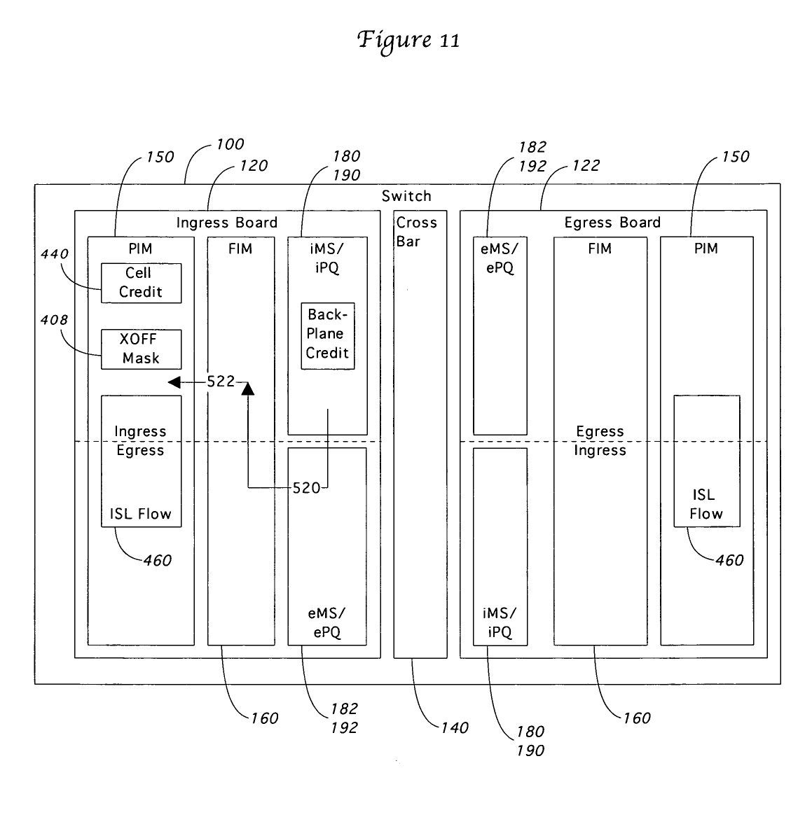

The cell-based switch fabric must be able to stop the flow of data from its data source (i.e., the FIM 160) whenever the iMS 180 or a V_O_Q 290 maintained by the iPQ 190 is becoming full. The switch fabric signals this XOFF condition by setting the RDY (ready) bit to 0 on the cells it returns to the FIM 160, shown as flow control 520 on FIG. 11. Although this XOFF is an input flow control signal between the iMS 180 and the ingress portion of the PPD 130, the signals are communicated from the eMS 182 into the egress portion of the same PPD 130. When the egress portion of the FIM 160 receives the cells with RDY set to 0, it informs the ingress portion of the PPD 130 to stop sending data to the iMS 180.

There are three situations where the switch fabric may request an XOFF or XON state change. In every case, flow control cells 520 are sent by the eMS 182 to the egress portion of the FIM 160 to inform the PPD 130 of this updated state. These flow control cells use the RDY bit in the cell header to indicate the current status of the iMS 180 and its related queues 290.

In the first of the three different situations, the iMS 180 may fill up to its threshold level. In this case, no more traffic should be sent to the iMS 180. When a FIM 160 receives the flow control cells 520 indicating this condition, it sends a congestion signal (or “gross_xoff” signal) 522 to the XOFF mask 408 in the memory controller 310. This signal informs the memory control module 310 to stop all data traffic to the iMS 180. The FIM 160 will also broadcast an external signal to the FIMs 160 on its PPD 130, as well as to the other three PPDs 130 on its I/O board 120, 122. When a FIM 160 receives this external signal, it will send a gross_xoff signal 522 to its memory controller 310. Since all FIMs 160 on a board 120, 122 send the gross_xoff signal 522, all traffic to the iMS 180 will stop. The gross_xoff signal 522 will remain on until the flow control cells 520 received by the FIM 160 indicate the buffer condition at the iMS 180 is over.

In the second case, a single V_O_Q 290 in the iMS 180 fills up to its threshold. When this occurs, the signal 520 back to the PPD 130 will behave just as it did in the first case, with the generation of a gross_xoff congestion signal 522 to all memory control modules 310 on an I/O board 120, 122. Thus, the entire iMS 180 stops receiving data, even though only a single V_O_Q 290 has become congestion.

The third case involves a failed link between a FIM 160 and the iMS 180. Flow control cells indicating this condition will cause a gross_xoff signal 522 to be sent only to the MCM 310 for the corresponding FIM 160. No external signal is sent to the other FIMs 160 in this situation, meaning that only the failed link will stop sending data to the iMS 180.

c) Output from Fabric Flow Control 530

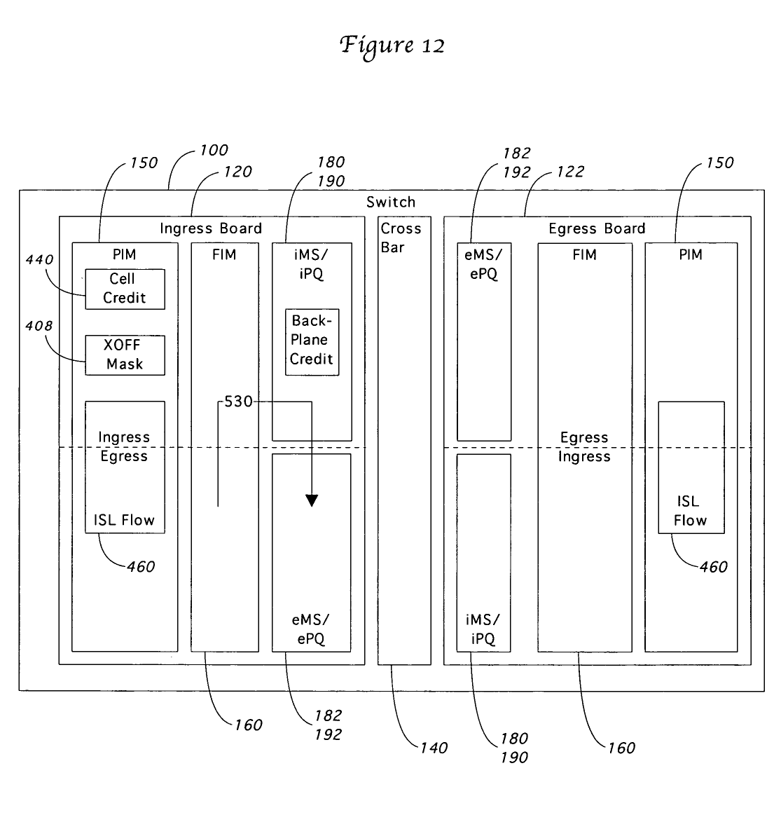

When an egress portion of a PPD 130 wishes to stop traffic coming from the eMS 182, it signals an XOFF to the switch fabric by sending a cell from the input FIM 160 to the iMS 180, which is shown as flow control 530 on FIG. 12. The cell header contains a queue flow control field and a RDY bit to help define the XOFF signal. The queue flow control field is eleven bits long, and can identify the class of service, port 110 and PPD 130, as well as the desired flow status (XON or XOFF).

The OPM 450 maintains separate buffers for real data heading for an egress port 114 and data heading for a microprocessor 124. These buffers are needed because buffering of data within the OPM 450 is often needed. For instance, the fabric interface module 160 may send data to the OPM 450 at a time when the link controller module 300 cannot accept that data, such as when the link controller 300 is accepting microprocessor traffic directed to the port 110. In addition, the OPM 450 will maintain separate buffers for each FIM 160 connection to the iMS 180. Thus, an OPM 450 that has two FIM 160 connections and handles both real data and microprocessor data will have a total of four buffers.

With separate real-data buffers and microprocessor traffic buffers, the OPM 450 and the eMS 182 can manage real data flow control separately from the microprocessor directed data flow. In order to manage flow control differently based upon these destinations, separate flow control signals are sent through the iMS 180 to the eMS 182.

When the fabric-to-port buffer or fabric-to-micro buffer becomes nearly full, the OPM 450 sends “f2p_xoff” or a “f2m_xoff” signal to the FIM 160. The FIM 160 then sends the XOFF to the switch fabric in an ingress cell header directed toward iMS 180. The iMS 180 extracts each XOFF instruction from the cell header, and sends it to the eMS 182, directing the eMS 182 to XOFF or XON a particular O_COS_Q 280. If the O_COS_Q 280 is sending a packet to the FIM 160, it finishes sending the packet. The eMS 182 then stops sending fabric-to-port or fabric-to-micro packets to the FIM 160.

As explained above, microprocessor traffic in the preferred embodiment is directed toward on PPD 3, port 3, COS 7. Hence, only the OPM 450 associated with the third PPD 130 needs to maintain buffers relating to microprocessor traffic. In the preferred embodiment, this third PPD 130 utilizes two connections to the eMS 182, and hence two microprocessor traffic buffers are maintained. In this configuration, four different XOFF signals can be sent to the switch fabric, two for traffic directed to the ports 110 and two for traffic directed toward the microprocessor 124.

6. Flow Control 540 Between PIM 150 and FIM 160

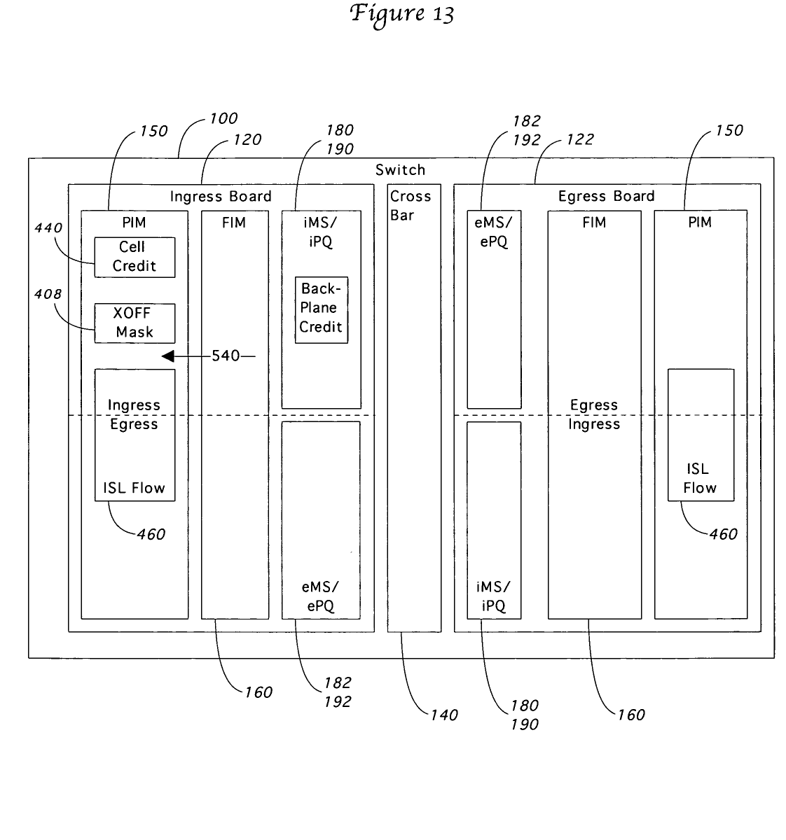

Flow control is also maintained between the memory controller module 310 and the ingress portion of the FIM 160. The FIM 160 contains an input frame buffer that receives data from the MCM 310. Under nominal conditions, this buffer is simply a pass through intended to send data directly through the FIM 160. In real world use, this buffer may back up for several reasons, including a bad link. There will be a watermark point that will trigger flow control back to the MCM 310. When the buffer level exceeds this level, a signal known as a gross_XOFF 540 (FIG. 13) is asserted, which directs the MCM 310 to stop all flow of data to the FIM 160.

7. Cell Credit Manager Flow Control 550

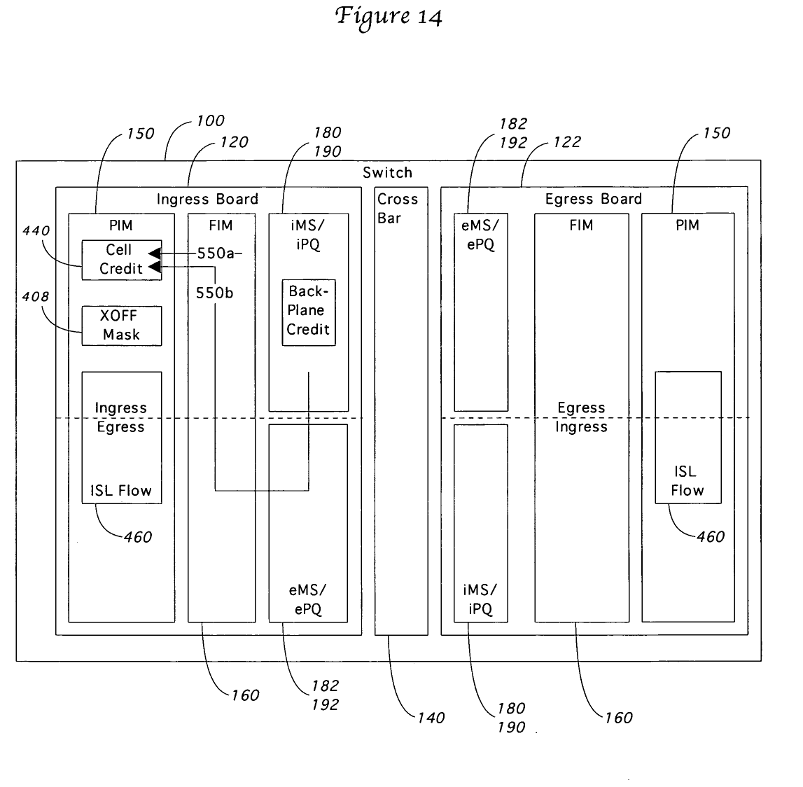

The cell credit manager or credit module 440 sets the XOFF/XON status of the possible destination ports 110 in the XOFF mask 408 and the XON history register 420. To update these tables modules 408, 420, the cell credit manager 440 maintains a cell credit count of every cell in the virtual output queues 290 of the iMS 180. Every time a cell addressed to a particular SDA leaves the FIM 160 and enters the iMS 180, the FIM 160 informs the credit module 440 through a cell credit event signal 550a (FIG. 14). The credit module 440 then decrements the cell count for that SDA. Every time a cell for that destination leaves the iMS 180, the credit module 440 is again informed (550b) and adds a credit to the count for the associated SDA. The iPQ 190 sends this credit information back to the credit module 440 by sending a cell containing the cell credit back to the FIM 160 through the eMS 182. The FIM 160 then sends an increment credit signal to the cell credit manager 440. This cell credit flow control is designed to prevent the occurrence of more drastic levels of flow control from within the cell-based switch fabric described above, since these flow control signals 500-520 can result in multiple blocked ports 110, shutting down an entire iMS 180, or even the loss of data.

In the preferred embodiment, the cell credits are tracked through increment and decrement credit events received from the FIM 160. These events are stored in separate FIFOs. Decrement FIFOs contain SDAs for cells that have entered the iMS 180. Increment FIFOs contain SDAs for cells that have left the iMS 180. These FIFOs are handled in round robin format, decrementing and incrementing the credit count that the credit module 440 maintains for each SDA. These counts reflect the number of cells contained within the iMS 180 for a given SDA. The credit module 440 detects when the count for an SDA crosses an XOFF or XON thresholds and issues an appropriate XOFF or XON event. If the count gets too low, then that SDA is XOFFed. This means that Fibre Channel frames that are to be routed to that SDA are held in the credit memory 320 by queue control module 400. After the SDA is XOFFed, the credit module 440 waits for the count for that SDA to rise to a certain level, and then the SDA is XONed, which instructs the queue control module 400 to release frames for that destination from the credit memory 320. The XOFF and XON thresholds, which can be different for each individual SDA, are contained within the credit module 440 and are programmable by the processor 124.

When an XOFF event or an XON event occurs, the credit module 440 sends an XOFF instruction to the memory controller 310, which includes the XON history 420 and all four XOFF masks 408. In the preferred embodiment, the XOFF instruction is a three-part signal identifying the SDA, the new XOFF status, and a validity signal. The credit module 440 also sends the XOFF instruction to the other credit modules 440 on its I/O board 120 over a special XOFF bus. The other credit modules 440 can then inform their associated queue controllers 400. Thus, an XOFF/XON event in a single credit module 440 will be propagated to all sixteen XOFF masks 408 on an I/O board 120, 122.

8. Flow Control Between Switches 560

a) Signaling XOFF Conditions for a Logical Channel 240

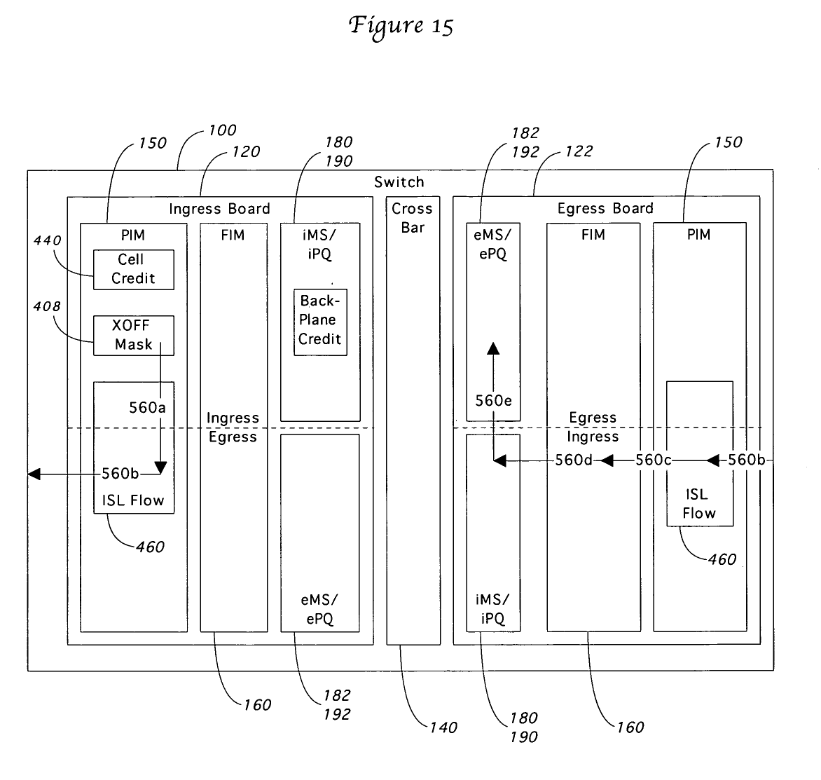

Referring now to FIGS. 6 through 8 and FIG. 15, the present invention is able to use the above described queuing mechanisms to control the flow over individual logical channels 240 on the ISL 230. This is shown as flow control 560 in FIG. 15. The ISL flow control component 460 in the downstream PPD 272 is responsible for initiating this flow control 560.

As seen in FIG. 6, the flow control component 460 includes a logical channel mask register (LCMR) 462, which is a multi-bit register having a bit for every possible destination within the switch. A separate LCMR 462 exists for each logical channel 240 across the ISL 230. The bits inside each LCMR 462 indicate which destinations are participating in that logical channel 240. The microprocessor 124 writes ‘1’ to the bit position in a logical channel mask 462 that corresponds to the destinations of that logical channel 240. For example, if port destinations 3, 20 and 7F (hex) were participating in a logical channel, then bit positions 3, 32, and 511 (decimal) would be set and all other bit positions would be held clear.

Each of the “n” LCMRs 462 create a complete mapping between one of the logical channels 240 on the attached ISL 230 and the ports 110 in the downstream switch 270 that are accessed by that logical channel 240. Thus, with one per each logical channel, the LCMRs 462 completely embody the virtual input queues (or V_I_Qs) 282 shown in FIG. 8. This mapping is essential to allow congestion on a physical port 110 in downstream switch 270 to be associated with a logical channel 240 on the ISL 230. Without it, it would not be possible to use knowledge about a congested port 110 on the downstream switch 270 to XOFF the logical channel or channels 240 that are submitting data to that port 110.

To determine whether a port 110 is congested, each LCMR 462 is connected to the XOFF mask 408 in queue control 400 (seen as message path 560a on FIG. 15). Alternatively, the LCMR 462 can be connected to the XON history register 420, which already needs the ability to output all status bits simultaneously when updating the XOFF mask 408. Either way, the XOFF bits are presented to the LCMR 462 from the XOFF mask 408 or XON history register 420. Only those XOFF bits that are set to “1” both at the XOFF mask 408/XON history register 420 and in the LCMR 462 pass through the LCMR 462 as set to “1”—all other bits will be set to “0”. All of these bits are then ORed together to provide a single XOFF bit for each logical channel 240. This means that any participant in a logical channel 240 that has an XOFF status causes an XOFF condition for the entire logical channel.

The current status register 464 receives the XOFF signals and converts them to an 8-bit current status bus 466, one bit for every logical channel 240 on the ISL. If more than eight logical channels 240 were defined on the ISL 230, more bits would appear on the bus 466. The current status bus 466 is monitored for any changes by compare circuitry 468. If a change in status is detected, the new status is stored in the last status register 470 and the primitive generate logic 472 is notified. If the port 110 is enabled to operate as an ISL 230, the primitive generate logic 472 uses the value on the current status bus 466 value to generate a special XOFF/XON primitive signal 560b to be sent to the upstream switch 260 by way of the ISL 230.

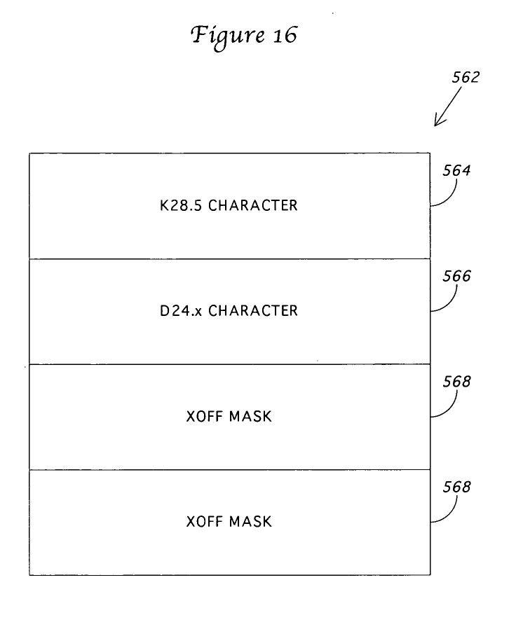

The XOFF/XON primitive signal 560b sends a Fibre Channel primitive 562 from the downstream switch 270 to the upstream switch 260. The primitive 562 sent is four bytes long, as shown in FIG. 16. The first byte of the primitive is a K28.5 character 564, which is used to identify the word as a primitive. The next character in the primitive 562 is a D24.x character 566, which can be a D24.1 character, a D24.2 character, a D24.3 character, etc. These D24.x characters are unused by other Fibre Channel primitives. Two identical copies of the XOFF mask 568 follow the D24.x character 566. The XOFF mask 568 is 8 bits long, each bit representing the XOFF status of a single virtual channel 240. The first two characters 564, 566 in the XOFF primitive 562 are chosen such that any XOFF mask 568 can be appended to them in duplicate and the primitive 562 will always end with negative running disparity, as is required by Fibre Channel protocols.

When more then eight logical channels 240 are used in the ISL 230, the primitive generate logic 472 runs multiple times. The second character 566 of the primitive indicates which set of XOFF signals are being transmitted. For example, the D24.1 character can be used to identify the primitive 562 as containing the XOFF status for channels 0 through 7, D24.2 can identify channels 8 through 15, D24.3 can identify channels 16 through 23, and D24.5 can identify channels 24 through 31.

When the primitive is ready, the primitive generate logic 472 will notify the link controller module 300 that the primitive 562 is ready to be sent to the upstream switch 260 out the ISL 230. When the primitive 562 is sent, the LCM 300 will respond with a signal so informing the ISL flow control 460. After approximately 40 microseconds, the primitive 562 will be sent again in case the upstream switch 260 did not properly receive the primitive 562. The process of sending the XOFF mask 568 twice within a primitive signal 560b, including the present status of all logical channels 240 within the signal 560b, and periodically retransmitting the primitive signal 560b insure robust signaling integrity.

The length of the interswitch link 230, together with the number of buffers available in credit memory 320, influence the effectiveness of logical channels 240. Credit memory 320 must buffer all frames in transit at the time XOFF primitive 562 is generated as well as those frames sent while the XOFF primitive 562 is in transit from the downstream switch 270 to the upstream switch 260. In the preferred embodiment, the credit memory buffers 320 will support single logical channel links 230 of one hundred kilometers. Considering latencies from all sources, an embodiment having eight logical channels 240 is best used with interswitch links 230 of approximately ten kilometers in length or less. Intermediate link distances will operate effectively when proportionately fewer logical channels 240 are active as link distance is increased.

b) Receiving XOFF Primitive Signal at Egress Port

The ISL egress port 114 receives the XOFF primitive 560b that is sent from the downstream switch 270 over the ISL 230. In FIG. 15, primitive 560b is shown being both sent and received by the same switch 100. This is done for the purpose of explaining the present invention. In the real world, the primitive 560b is sent by the downstream switch 270 and received by the upstream switch 260. When the LCM 300 receives the XON/XOFF primitive 562 sent by the downstream switch 270, the LCM 300 will recognize the primitive 562 and send it directly to the frame check logic 480 of the ISL flow control module 460. The frame check logic 480 checks that the 3rd and 4th bytes of the primitive 562 are equal, strips the XOFF mask 568 from the primitive 562, and places it in the status received register 482. This register 482 has a single bit for every logical channel 240 on the ISL 230. Since the current XOFF status is the only status that is of concern, the status register 482 is always overwritten. However, if the 3rd and 4th bytes are not equal in value, then primitive 562 is considered invalid, the status register 482 is not updated and the last status is used until the next valid special primitive 562 is received.

Compare logic 484 determines when status received register 482 has changed and on which logical channels 240 status has changed. When a status bit changes in the register 482, a cell must be generated and sent into the fabric to notify the O_COS_Q 280 to stop sending data for that logical channel 240. The flow control cell arbiter 486 is used to handle cases where more than one status bit changes at the same time. The arbiter 486 may use a round robin algorithm. If a cell has to be generated to stop an O_COS_Q 280, the arbiter 486 sends to the FIM 160 a generate signal and a status signal (jointly shown as 560c in FIG. 15) for that O_COS_Q 280. The generate signal indicates to the FIM 160 that a flow control cell 560d must be generated and the status signal indicates whether the cell should be an XOFF cell or an XON cell. This cell 560d is then received at the iMS 180, and the iMS 180 instructs the eMS 182 (signal 560e) to XOFF or XON the designated O_COS_Q 280. The fabric interface module 160 informs the arbiter 486 when the flow control cell 560d has been generated. The arbiter 486 can then assert the generate signal for the next highest priority status bit that needs attention.

When the O_COS_Q 280 for a virtual channel 240 is stopped as a result of the ISL flow control signaling 560 received from the downstream switch 270, data in that O_COS_Q 280 will stop flowing from the upstream switch 260 across the ISL 230. Once this occurs, backplane credits 510 will stop being returned across the crossbar 140 from this queue 280 to the iPQ 190. When the iPQ 190 runs out of credits, no more data cells will be sent from the V_O_Q 290 that is associated with the port 110 of the stopped O_COS_Q 280. At this point, the V_O_Q 290 will begin to fill with data. When the threshold for that queue V_O_Q 290 is passed, the iPQ 190 will send a flow control signal 520 to the PPD 130. This flow control signal 520 indicates that the port 110 associated with the filled V_O_Q 190 now has a flow control status of XOFF. This will cause an update to the XOFF mask 408 in memory controller 310. The update to the XOFF mask 408 might in turn cause a new ISL flow control signal 560 to be created and sent to the next switch upstream. In this way, flow control on a virtual channel 240 in an ISL 230 can extend upstream through multiple switches 100, each time stopping only a single virtual channel 240 in each ISL 230.

c) Switch Buffer to Buffer Flow Control

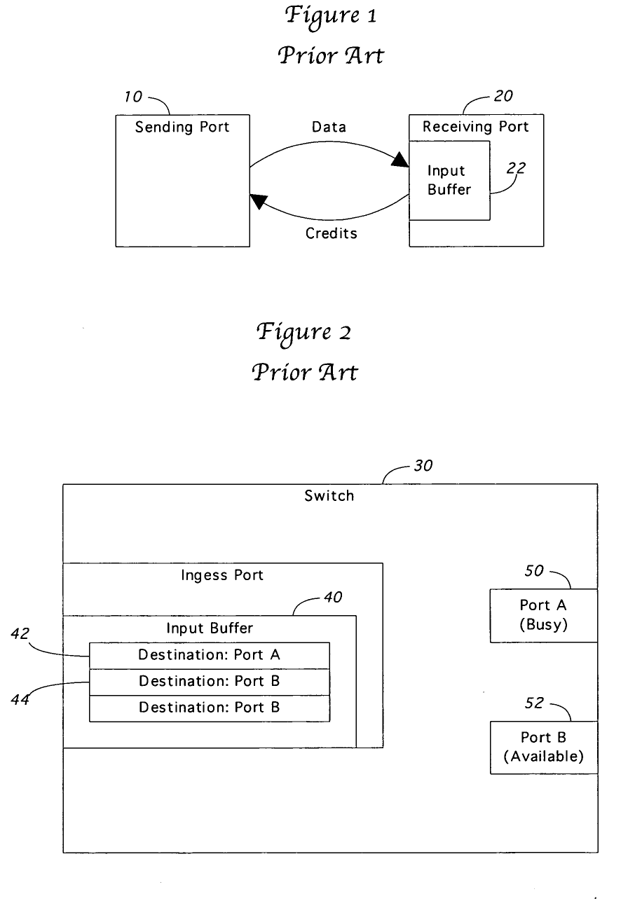

When two switches 260, 270 are connected together over an interswitch link 230, they utilize the same buffer-to-buffer credit based flow control used by all Fibre Channel ports, as shown in FIG. 1. This means that the primitive XOFF signaling 560 that is described above operates in cooperation with the basic BB_Credit flow control over the entire ISL 230.

d) Alternative Virtual Channel Flow Control Techniques

The above description reveals a method of using XOFF/XON signaling to perform flow control on individual virtual channels within an interswitch link. Other techniques would also be available, although they would not be as effective as the technique described above. For instance, it would be possible to simple assign a portion of the credit memory 320 to each virtual channel 240 on an ISL 230. Credits could be given to the upstream switch 260 depending on the size of the memory 320 granted to each channel 240. The upstream switch 260 could then perform credit based flow control for each virtual channel 230. While this technique is more simple than the method described above, it is not as flexible. Furthermore, this technique does not provide the flow control redundancies of having XOFF/XON signaling for each virtual channel 240 within the context of BB_Credit flow control for the entire ISL 230.

Another alternative is to send the entire XOFF mask 408 to the upstream switch 260. However, this mask 408 is much larger than the primitive 562 used in the preferred embodiment. Furthermore, it could be difficult for the upstream switch 260 to interpret the XOFF mask 408 and apply the mask 408 to the virtual channels 240.

9. Class F Frames: Establishing an ISL

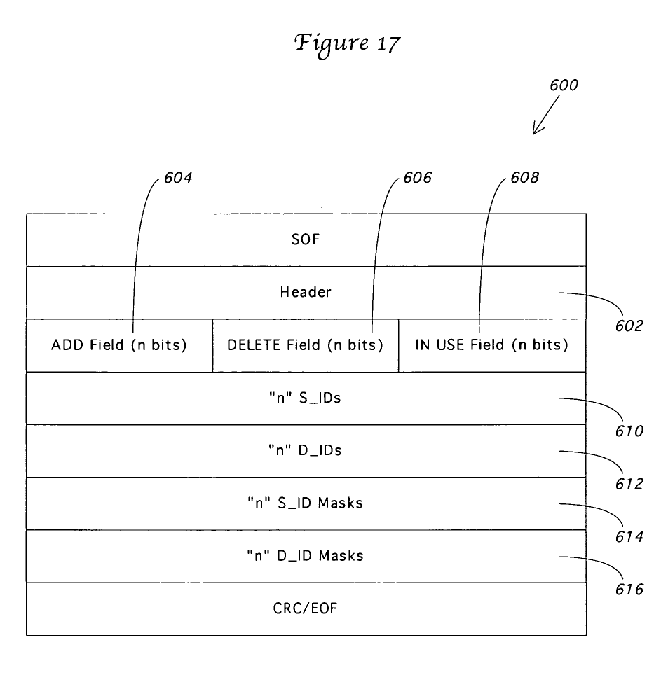

The two switches 260, 270 that communicate over the ISL 230 must establish various parameters before the ISL 230 becomes functional. In all Fibre Channel networks, communication between switches 260, 270 to establish an ISL 230 is done using class F frames. To allow the switches 260, 270 to establish the virtual channels 240 on an ISL 230, the present invention uses special class F frames 600, as shown in FIG. 17. In the preferred embodiment, the F class frames 600 contain a standard header 602 with the R_CTL value set to x0F (vendor specific class F frame), and both the D_ID and the S_ID set to the fabric controller address (xFFFFFD).

The data payload of frame 600 establishes the logical channel map of the ISL 230. The data portion begins with three fields, an Add field 604, a Delete field 606 and an In Use field 608. Each of these fields is “n” bits long, allowing one bit in each field 604-608 to be associated with one of the “n” logical channels 240 in the ISL 230. Following these fields 604-608 are four multi-valued fields: S_ID values 610, D_ID values 612, S_ID masks 614, and D_ID masks 616. Each of these fields 610-616 contains a total of n values, one for each virtual channel 240. The first entry in the S_ID values 610 and the first entry in the D_ID values 612 make up an S_ID/D_ID pair. If the first bit in the Add field 604 is set (i.e., has a value of “1”), this S_ID/D_ID pair is assigned to the first virtual channel 240 in the ISL 230. Assuming the appropriate bit is set in the ADD field 604, the second S_ID/D_ID pair is assigned to the second virtual channel 240, and so on. If a bit is set on the Delete field 606, then the corresponding S_ID/D_ID pair set forth in values 610 and 612 is deleted from the appropriate virtual channel 240. If the bit value in the Add field 604 and the Delete field 606 are both set (or both not set), no change is made to the definition of that virtual channel 240 by this frame 600.

The mask fields 614, 616 are used to mask out bits in the corresponding values in the S_ID/D_ID pair established in 610, 612. Without the mask values 614, 616, only a single port pair could be included in the definition of a logical channel 240 with each F class frame 600. The S_ID/D_ID mask pairs will allow any of the bits in an S_ID/D_ID to be masked, thereby allowing contiguous S_ID/D_ID pairs to become assigned to a logical channel 240 using a single frame 600. Non-contiguous ranges of S_ID/D_ID pairs are assigned to a virtual channel 240 using multiple F class frames 600.

The logical channel In Use field 608 is used to indicate how many of the “n” paths are actually being used. If all bits in this field 608 are set, all virtual channels 240 in the ISL 230 will be utilized. If a bit in the field 608 is not set, that virtual channel 240 will no longer be utilized.

The switch 100 uses the information in this F class frame 600 to program the inbound routing module 330. The module 330 assigns a priority to each frame destined for the ISL 230 according to its S_ID/D_ID pair and the assignment of that pair to a logical channel 240 according to the exchanged F class frames 600.

The many features and advantages of the invention are apparent from the above description. Numerous modifications and variations will readily occur to those skilled in the art. For instance, it would be a simple matter to define the virtual channels 240 by simply dividing the entire Fibre Channel address space into “n” channels, rather than using the F class frames 600 described above. In addition, persons of ordinary skill could easily reconfigure the various components described above into different elements, each of which has a slightly different functionality than those described. Neither of these changes fundamentally alters the present invention. Since such modifications are possible, the invention is not to be limited to the exact construction and operation illustrated and described. Rather, the present invention should be limited only by the following claims.

What is claimed is:

1. A method for flow control over a link comprising:
a) dividing the link into a plurality of virtual channels;
b) storing information received over the link in a plurality of output queues;
c) establishing a map between a first virtual channel and a set containing a plurality of output queues; and
d) restricting a flow of data over the first virtual channel when a data level in one of the output queues in the set reaches a threshold.

2. The method of claim 1, wherein the link is subject to buffer to buffer flow control.

3. The method claim 1 wherein the link is an interswitch link between an upstream switch and a downstream switch.

4. The method of claim 3, wherein the step of restricting a flow of data further comprises sending an XOFF signal from the downstream switch to the upstream switch.

5. The method of claim 4, wherein the link is subject to buffer to buffer flow control.

6. The method of claim 4, wherein the XOFF signal includes an indication of flow control status for all virtual channels on the link.

7. The method of claim 6, wherein the XOFF signal is repeated twice to ensure reception by the upstream switch.

8. The method of claim 6, wherein the indication of flow control status for all virtual channels is an XOFF map having a single bit representing a flow control status for each virtual channel on the link.

9. The method of claim 6, wherein the XOFF signal is a single Fibre Channel primitive.

10. The method of claim 9, wherein the indication of flow control status for all virtual channels is repeated within a single Fibre Channel primitive.

11. The method of claim 6, wherein
i) the XOFF signal is a plurality of Fibre Channel primitives,
ii) the indication of flow control status for all virtual channels is an XOFF map having a single bit representing a flow control status for each virtual channel on the link, and
iii) each Fibre Channel primitive has a single XOFF mask of eight bits in length and each of the plurality of Fibre Channel primitives communicates the flow control status of a different set of eight virtual channels.

12. The method of claim 11, wherein the XOFF mask is repeated in each primitive.

13. The method of claim 12, wherein each primitive includes other characters in addition to the XOFF mask, wherein the other characters are chosen to ensure the transmission of each primitive ends with negative running disparity.

14. The method of claim 13, wherein the other characters are a K28.5 character and a D24.x character.

15. A method for handling flow control at a downstream switch having a plurality of ports, the downstream switch receiving information over an interswitch link having a plurality of virtual channels, the method comprising:
a) establishing a map between each virtual channel and the ports assigned as possible destination ports for that virtual channel;
b) tracking a flow control status for each of the plurality of ports; and
c) comparing the map and the flow control status of the plurality of ports to determine a flow control status for each virtual channel.

16. The method of claim 15, further comprising:
e) monitoring the flow control status for each virtual channel; and
f) transmitting a flow control signal across the interswitch link whenever the monitoring step detects a change in flow control status for any virtual channel.

17. The method of claim 16, wherein the flow control signal includes the current flow control status of all virtual channels.

18. A method of flow control over a Fibre Channel link comprising:
a) maintaining buffer-to-buffer credit flow control over the entire link;
b) dividing the link into multiple virtual channels;
c) sending a flow control signal from a downstream device to an upstream device;
d) in response to receiving the flow control signal at the upstream device; restricting data flowing over a first virtual channel while not restricting data flowing over a second virtual channel.

19. A method of flow control over a communication link at a downstream switch comprising:
a) receiving data on a first virtual channel on the link at the downstream switch;
b) determining a destination port on the downstream switch for the data;
c) determining a flow control status for the destination port;
d) sending a flow control signal from the downstream switch over the communication link so as to restrict flow control over the first virtual channel when the destination port has an XOFF status; and
e) continuing to receive data across the link on a second virtual channel after sending the flow control signal.

20. The method of claim 19, further comprising:
f) placing the data in a deferred queue if the flow control status for the destination port is XOFF.

21. A method for submitting data over a plurality of virtual channels on a data link comprising:
a) assigning the data to one of a plurality of output queues, each output queue handling data for a single virtual channel on the link;
b) submitting the data to the link from the plurality of output queues using a traffic shaping algorithm;
c) receiving a flow control signal over the data link; and
d) in response to the flow control signal, stopping the flow of data from one of the plurality of output queues while continuing to submit data from the remaining output queues.

22. The method of claim 21, wherein the method operates on an Fibre Channel switch.

23. The method of claim 21, wherein the traffic shaping algorithm is a round robin algorithm.

24. The method of claim 22, wherein the round robin algorithm gives equal weight to each output queue.

25. A data switch comprising:
a) a port connected to an interswitch link having a plurality of virtual channels;
b) a plurality of output queues; and
c) a virtual input queue mapping between a first virtual channel and a set containing a subset of the plurality of output queues.

26. The switch of claim 25, further comprising:
d) an indicator indicating when one of the output queues in the set reaches a threshold.

27. The switch of claim 26, wherein the indicator is an XOFF mask containing a plurality of bits, each bit indicating the status of each output queue.

28. The switch of claim 27, further comprising:
e) a cell credit module that monitors cell credit for each output queue and updates the XOFF mask when the cell credit hits a threshold value.

29. The switch of claim 25, wherein the virtual input queue is a plurality of masks, one mask for each virtual channel, each mask indicating the output queues receiving data from the virtual channel.

30. The switch of claim 25, wherein each output queue is associated with a single port on the switch.

31. A data network comprising:
a) means for establishing an interswitch link between two switches, the interswitch link having a plurality of virtual channels;
b) means for communicating flow control information about the virtual channels between the switches; and
c) means for restricting the flow of information on a first virtual channel in response to the flow control information without restricting the flow of data on a second virtual channel.

32. A data switch comprising:
a) means for establishing an interswitch link with an upstream switch, the interswitch link having a plurality of virtual channels;
b) means for monitoring the flow control status of a plurality of ports within the data switch;
c) means for determining a flow control status for each virtual channel in the interswitch link; and
d) means for communicating a change in flow control status for a particular virtual channel to an upstream switch.

33. A communications device comprising:
a) a plurality of output queues, each output queue handling data for a single virtual channel on the link;
b) means for submitting the data to the link from the plurality of output queues using a traffic shaping algorithm;
c) means for receiving a flow control signal; and
d) means for stopping the flow of data from one of the plurality of output queues while continuing to submit data from the remaining output queues.
